(19) United States
(12) Patent Application Publication
(10) Pub. No.: US 2016/0381027 A1
(43) Pub. Date: Dec. 29, 2016

(54) SYSTEM AND METHOD FOR DETECTING AND REPORTING SURREPTITIOUS USAGE

(71) Applicant: Location Sentry Corp, Camas, WA (US)

(72) Inventors: Ryan James MITCHELL, Portland, OR (US); Craig E. SPIEGELBERG, Washougal, WA (US)

(73) Assignee: LOCATION SENTRY CORP, CAMAS, WA (US)

(21) Appl. No.: 15/196,036

(22) Filed: Jun. 29, 2016

Related U.S. Application Data
(60) Provisional application No. 62/231,263, filed on Jun. 29, 2015.

(51) Int. Cl. H04L 29/06; H04W 4/02; H04W 52/02; H04L 12/24

(52) U.S. Cl. CPC H04L 63/10; H04L 63/1433; H04L 41/22; H04W 4/026; H04W 52/0264; H04W 88/02

(57) ABSTRACT

A system and method for determining access and use of sensor and communication peripheral subsystems on a wireless device using resource consumption for the purpose of notifying and securing user privacy.

### CROSS REFERENCE AND RELATED APPLICATIONS

This application claims priority under 35 USC 119 from U.S. Provisional Application Ser. No. 62/231,263 filed on Jun. 29, 2015, titled SYSTEM AND METHOD FOR DETECTING AND REPORTING SURREPTITIOUS USAGE by James MITCHELL et al., the entire disclosure of which is incorporated herein by reference.

### BACKGROUND

With the explosive growth in mobile devices, wireless data rates and mobile-based software applications, the security and privacy needs of the user of wireless devices such as smartphones, tablet computers, and wireless LAN-equipped netbooks, laptop portable computers or voice-over-IP phones with nomadic capabilities.

In the rush to establish gain market share, device manufacturers modified existing operating systems (e.g. UNIX, LINUX, Microsoft Windows, POSIX, NeXT, BSD) and added hardware subsystems and sensors (e.g. cameras, accelerometers, GPS receivers, infrared transceivers, Wi-Fi transceivers, Bluetooth transceivers, and digital signal processors) without due consideration to the unique security and privacy situation of a device as private and personal as a wireless device.

The ‘user plane’ approach implemented in wireless device allows a mobile device to communicate over wireless data backhaul (e.g. cellular, wireless LAN) with networked landside servers. The user-plane approach favors use of device-based and device-assisted location techniques such as use of satellite broadcasts (e.g. Global Positioning System (GPS), Galileo, GLONASS) for precise positioning and infrastructure-based techniques such as cell-id (a proximity location based on the detection of base station, access point beacons, or television broadcast from known transmitters at known transmission sites) or enhanced cell ID (location based on the detection of base station, access point beacons, or television broadcast from known transmitters at known transmission sites with known timing or broadcast power levels allowing for time and/or power-based ranging).

If multiple beacons can be detected, a radio fingerprinting approach, based on the powers of the received signals and either propagation models or uploaded calibration data, can be used for coarse localization.

The cellular base stations are also known as Base Transceiver Sites (BTS), Radio Base Stations (RBS), NodeB's (NB) and eNodeB's (eNB) depending on the radio technology or the manufacturer of the base station(s). The term Access Point (AP) includes wireless local area network (W-LAN) technologies and protocols such as IEEE 802.11, 802.16 and Bluetooth.

Consumer devices, especially mobile battery powered devices, are commonly designed to assume low-power consumption states when not in active use. Multi-threaded operating system such as UNIX variants or WINDOWS™ support priority levels for processes, allowing for re-prioritization of processes to maximize battery life. Applications running under the operating system signal the user as to the application priority and power status by running on the main user interface screen, minimized, or in the background. This background state is known also known as stand-by.

Battery life, thus time between charging, is available to the user via applications that monitor both software applications and peripheral subsystems such as radios (which depending on manufacturer selections can include cellular modem(s), Wireless Local Area Network (WiLAN (e.g. WIFI)), near-field communications (NFC), Bluetooth)) as well as infrared transceiver(s), digital cameras, microphones, compass (magnetometer), accelerometer(s), and the like.

The inventive techniques and concepts described herein apply to operating systems such as, and including; Android, iOS, Windows Mobile, Blackberry, Symbian, PalmOS, Firefox OS and Ubuntu Mobile/Ubuntu for phones. The Android-based model discussed is an exemplary but not exclusive environment in which the present invention may be used.

### SUMMARY

Mobile device (e.g. Cell phone, smart phones, and tablets) users are often completely unaware of how often a particular application is accessing the user's precise location using the GNSS receiver.

Using the mobile device's battery use statistics a proxy measurement can be developed. For a specific interval of mobile use (i.e. not being charged) the battery use of an application accessing a peripheral (e.g. a sensor or communications transceiver) can be used as a proxy for the activity (e.g. number of location fixes made).

Using the proxy sum of power usage per application, the report to the user can be number of fixes per application per time period.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWING

The foregoing summary as well as the following detailed description is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 schematically depicts a functional representation of power consumption monitoring in a wireless device.

FIG. 2 graphically illustrates the power consumption recording for peripherals and subsystems of the wireless device.

FIG. 3 shows an exemplary illustration of the foreground and background mode of operation.

FIG. 4 depicts the use of power consumption in monitoring security and privacy by the Threat Monitor.

FIG. 5. Schematically depicts the calibration of the Threat Monitor.

FIG. 6 depicts the use of a landside server in the collection of application permissions and behaviors.

### DETAILED DESCRIPTION

Wireless devices have changed in both operation and form-factors, converging the personal computer (PC) with the cellular phone and other communications devices. Besides communications functions (e.g. Voice Telephony, Short-message-service (SMS), Multi-media Messaging Service (MMS), TCP/IP data connectivity) and upgraded general processing power, peripherals such as sensors have been added to the wireless device. For instance, a wireless device (e.g. a smartphone, feature phone, netbook, Personal Digital assistant (PDA), tablet computer or PC with wireless LAN capability) can have:

Camera/Video functions

Location data (Satellite-based)

Location data (Mobile-based)

Location data (Network-based)

Motion data (compass, accelerometer, gravitational sensor)

Capacitive Sensors

Address Book, Contacts lists, recent called/emailed data.

Application specific sensing, reading and monitoring capabilities

The wireless device can also have multiple networking capabilities including nomadic wired tethering, local-area-network transceivers (e.g. IEEE802 Wi-Fi), wide-area-network transceivers (IEEE 802.16 WiMAN/WiMAX, cellular data transceivers, (e.g. LTE) and short-range, data-only wireless protocols such as Ultra-wide-band (UWB), Bluetooth, RFID, Near-field-communications (NFC), etc.

Access to these peripheral sensors and communications transceivers by applications is controlled by permissions set by the user on installation if the user is allowed to set permissions for a specific application at all (i.e. the application is pre-loaded by the manufacturer, the OS creator, the OS vendor, and/or the wireless network operator).

In the normal course of operation, the user of the device opens and closes applications, at need, using the graphical user interface (GUI) provided by the device's manufacturer or operating system provider. By closing an application, the user action can be interpreted by the Operating System as a signal to shutdown the application, killing the associated processes and releasing memory allocations for reuse. The closing of the application can also be interpreted as a signal to minimize the application, continuing its associated processes and memory allocations while perhaps de-prioritizing it in the contention for processor cycles, peripheral access, and/or memory allocation.

In the case of location-based applications, a user may want to initiate privacy or preserve battery life by closing a particular application known or suspected of requesting location access. While the application appears to the user to have exited, the actual operation of the application, its access to location and other private information, its access to onboard sensors and other peripherals, the application's process(s) priority and power consumption, its use of backhaul bandwidth via one or more transceivers may or may not be in any way limited.

A knowledgeable user can prevent application access to peripherals such as sensors and transceivers information by turning off basic services. From the ANDROID Security Overview:
“Within the device settings, users are able to view permissions for applications they have previously installed. Users can also turn off some functionality globally when they choose, such as disabling GPS, radio, or wi-fi.”

So location security can be enforced by disabling basic functionality, crippling not only the suspect application, but all legitimate, desired applications that use that function. Also, experience has shown that turning on disabled functionality from within a specific application's user dialogue enables that functionality for all applications until globally disabled again.

The ability of the user to ‘turn off’ sensors or transceivers may then be nullified by the application permission's which can include the ability to modify the state of the peripherals and bring them back online.

An independent way for the user to see what applications are doing; what peripheral subsystems are active (or activated), how much data is being sent, and how power hungry each application is when supposedly inactive is needed.

### A. Use of Power Consumption as Proxy

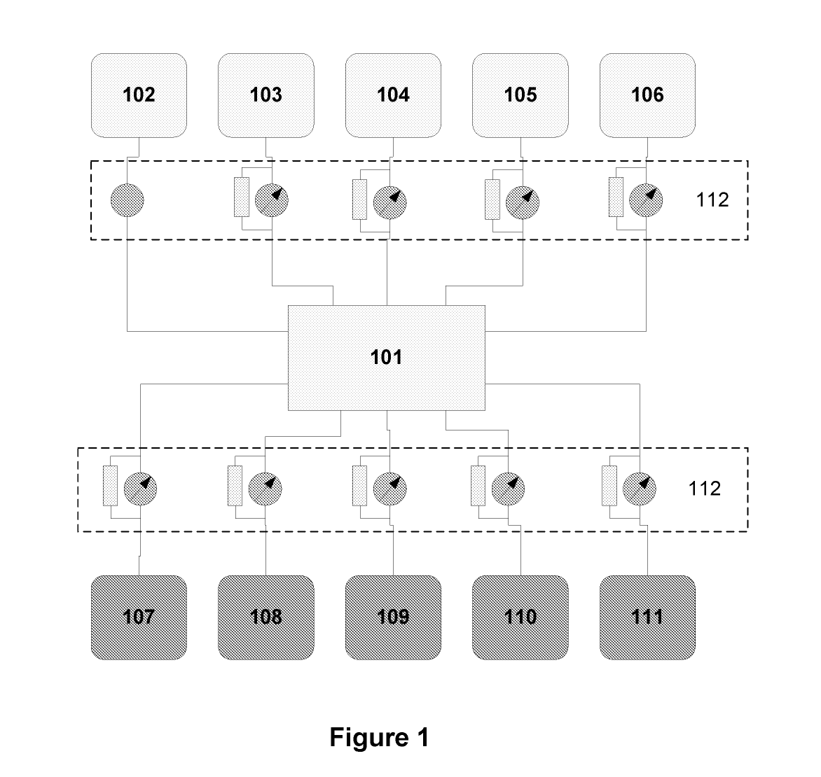

FIG. 1 depicts a conceptual depiction of the power monitoring in the wireless device. The power monitoring application 101 is connected to each application 102 103 104 105 106 or peripheral subsystem 107 108 109 110 111 via a power meter (depicted here as banks 112 of power meters (voltage and amperage or just amperes if voltage is known)). The actual implementation of the power consumption measurement is unimportant here and may be generated by dedicated circuitry, shared circuitry, by

CPU cycles consumed or by predictive modeling.

For each application 102 103 104 105 106 and peripheral communications and sensor subsystem (e.g. GPS, WLAN transceiver, cellular modem, IR transceiver, video camera, microphone, accelerometer, magnetometer, proximity sensor), the power consumption can be used as a proxy for amount of use. With the link between application and peripheral, a connection between application and the use of a peripheral can be established.

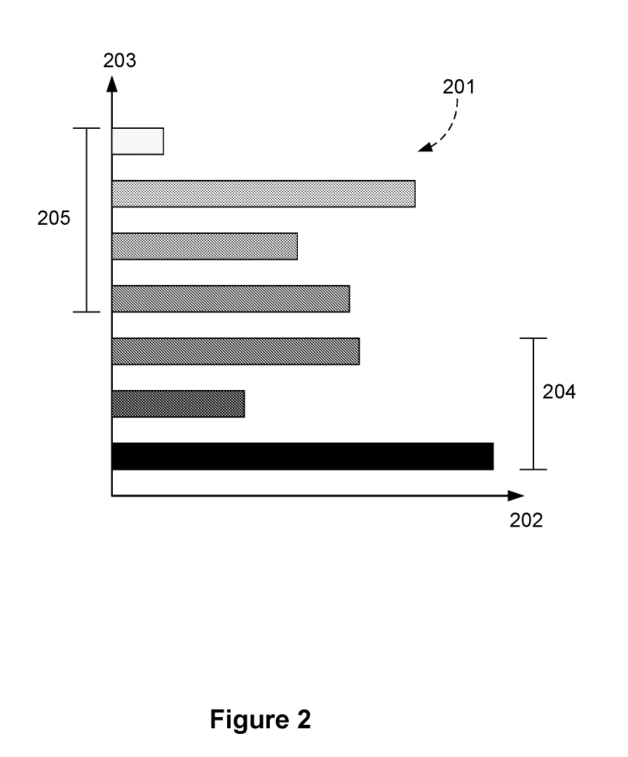

FIG. 2 graphically shows the collected power consumption 201, wherein the X-axis 202 shows power consumption since removal from battery charger for an example set of apps 204 and peripheral subsystems 205 spread over the Y-axis 203.

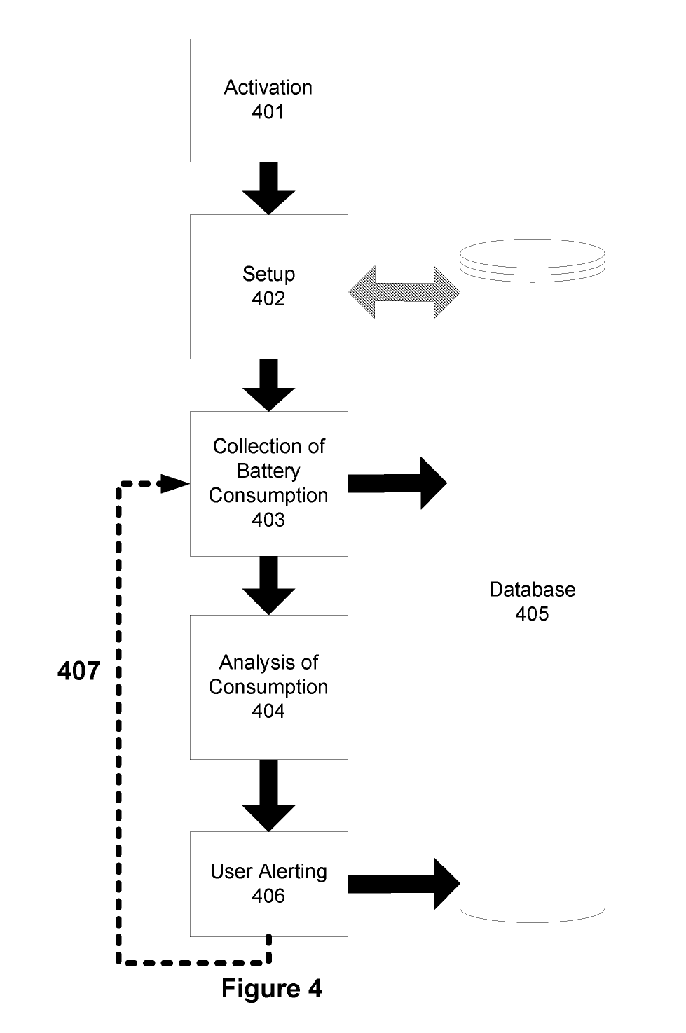

FIG. 4 shows the representative process for use of the Threat Monitor Application (TMA). A presumption of a successful install and permission granting for the application is assumed prior to activation 401. TMA can be activated 401 as a user level or root level application depending on the owner or installer's permission level. In FIG. 4, the lowest level of privilege (user) is assumed as is the continued availability of the power consumption data.

TMA setup includes an upload from the persistent TMA database 405. If preference, configuration or calibration data is stored in the database 405, it will be uploaded into the TMA. A default rule set or an interactive session with the user may also be used to set the application privacy and security rules during setup 402.

The collection of power consumption 403 may be periodic, ad Hoc at user request, triggered by peripheral activation or software-based interrupts. For each power consumption reading, the information is stored in the database 405. This storage in the TMA database 405 is outside the offered power consumption data which is reset each time the battery is changed or charged.

In response to a reporting event (e.g. the user makes a request, a periodic or pre-programmed time interval is reached), the power consumption of the applications and peripherals is analyzed 404. Dependent on the rules uploaded or otherwise entered during setup 402, the user may be alerted 406 to suspicious behavior by an application. This behavior may be use of a peripheral for the first time or with greater frequency than baselined or allowable (based on the TMA settings or history).

Another alert may be the issuing of a report to the user showing the applications that most activate a peripheral or activate the peripheral when the application is not running active in display mode.

### B. User Security and Privacy Interaction

For the non-technical user of the smartphone, wireless tablet or other wireless device, the inner workings of the device are rather opaque. One way of signaling the user as to the trustworthiness of an application is to show that application's behavior. Using the classic out-of-sight, out-of-mind gambit, many applications that generate (via the onboard sensor peripherals) and report (via the wireless communications facilities (e.g. cellular, wi-fi, optical) launch and run without visible indications to the user. One method of demonstrating to the user the insecurity of the device and the suspicious, if not malicious, behavior of applications is the use of the foreground and background operations of the application(s).

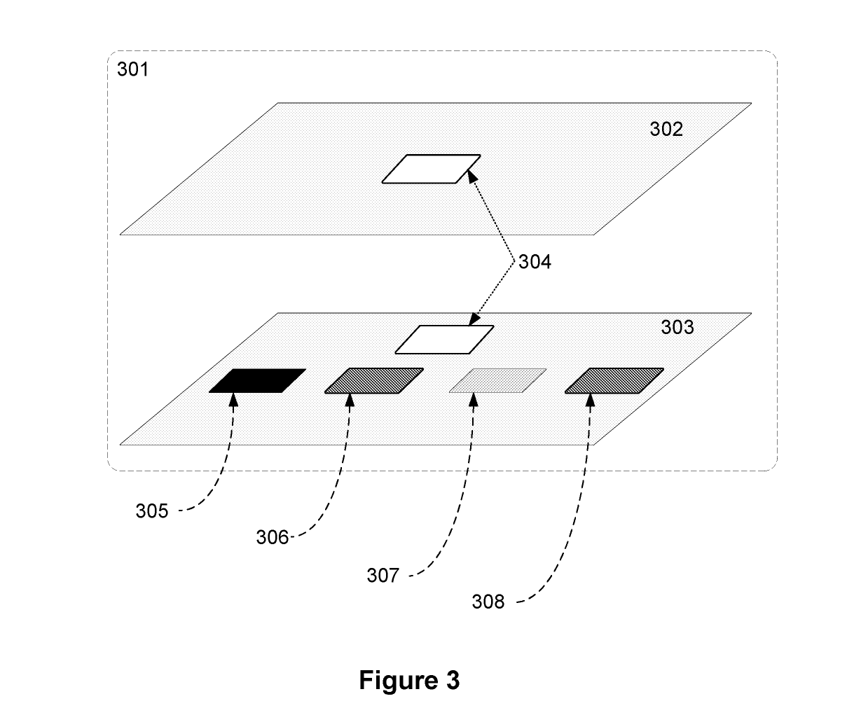

FIG. 3 presents a conceptual view of the foreground and background operation of applications in the device 301. The foreground 302 is shown with a single application 304. This mode of operation, where a single application 304 uses the entire display, is typical in wireless devices with single, small screen displays. The user, naively, assumes that other applications are off, on-standby, or otherwise quiescent when another application uses the display or the display is turned off. In the FIG. 3 conceptual diagram, the display being off means no application would appear in the foreground plane 302.

As depicted in FIG. 3, the background plane is host to multiple applications which include any foreground applications 304 as well as operating system application(s) 305, manufacturer installed applications 306, carrier installed applications 307 and user installed and previously activated applications 308 running without presenting to the display. The behavior of applications, especially the activation of peripherals and transmission of information while transitioning from the foreground or while in background mode can be found using power consumption.

### C. Calibration Techniques

One enhancement to the use of battery use as a proxy measurement for application peripheral access is the use of calibration.

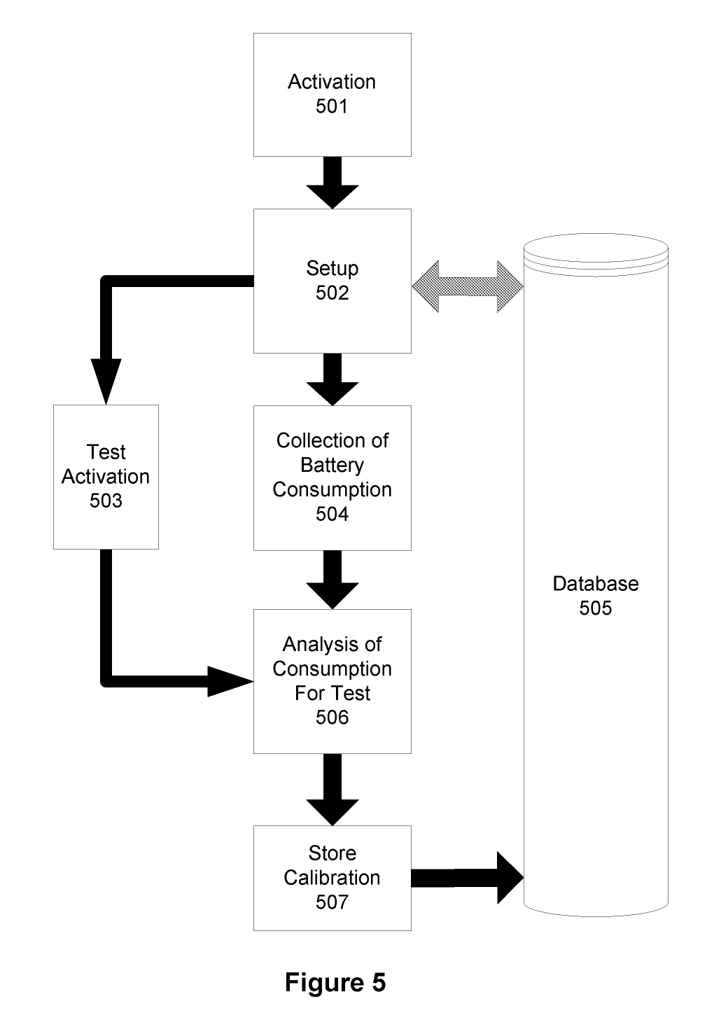

FIG. 5 depicts the representative steps for generating and storing calibration data for each communications or sensor peripheral. After activation 501, the Threat Monitor Application (TMA) enters setup 502 with an attempt to load prior session data, device configuration information, and user preferences. Again, a presumption of a successful install and permission granting for the application is assumed prior to activation 501. The TMA can be activated 501 as a user level or root/system level application depending on the owner or installer's permission level. In FIG. 5, the lowest level of privilege (user) is assumed as is continued availability of the power consumption data.

TMA setup 501 includes an attempt to upload from the persistent TMA database 505. If preference, configuration or calibration data is stored in the database 505, it will be uploaded into the TMA. A default rule set or an interactive session with the user may also be used to set the application privacy and security rules during setup 502.

In FIG. 5, setup includes the initiation of calibration. The TMA will interact with allowed applications and peripheral subsystems one-by-one, collecting power consumption data for each interaction. This interaction may be the activation of the peripheral (e.g. requesting and receiving a location estimate, taking a picture, requesting and receiving a pre-set, defined period of audio, transmission of a predefined package of digital information to an outside server, reception of a package of digital information to an outside server). As each application or peripheral interaction is completed 503, the battery consumption is collected 504.

The analysis of the power consumption 506 is performed to clean up the recorded data. A test and measurement interval for power consumption where multiple applications requested the same service would result in erroneous calibration data, and thus a repetition of the test 503 and measurement and collection 504 session for that service would be rescheduled.

Once a clean set of calibration data is stored 507 in the database 505, the TMA will use that calibration data to format the report and alerting messages with sizes and instances (e.g. the cellular radio was activated and 1024 bytes were transmitted by application “X” or application “Y” activated the GNSS receiver 6 times in between time “A” and time “B”).

Illustrative Example: Global Navigation Satellite System (GNSS) location

In one illustrative example of calibration, by using the GNSS (e.g. GPS) sensor to generate location fixes (a single fix or multiple) by the monitoring program itself, the power consumption for that activity can be used as a calibration baseline allowing for an estimate of the number of accesses (location fixes in this example) by a particular application.

Another benefit of calibration is that differing mobile devices may use different transmitters, receiver(s), and/or different satellite constellations (for GNSS locations) making an accurate power-per-fix estimate difficult to predict across a wide range of devices and communication networks. Since calibration works on a per-device, per peripheral basis, a unique baseline profile is computed for each device and can be recomputed at need (for instance as battery ages or network protocols use ratios change (e.g. as primarily UMTS networks transition to more bandwidth efficient OFDMA networks such as LTE)).

### D. User Prompted Interactions

While the Threat Monitor can warn the user, the device user, interruption (e.g. “Force Stop” in ANDROID) of an application or suspension (e.g. “Disable” in ANDROID) of the offending (those that violate the operational constraints setup in TMA) application(s) cannot be automatically accomplished by another a user-level permission application such as Threat Monitor.

Using Threat Monitor with pop-up warnings will allow the user to manually interrupt or suspend the offending application using the privileged user interface where higher privileged (those installed by the OS provider, device manufacturer, device reseller, wireless carrier for instance) applications would normally be allowed to be affected.

If Threat Monitor is installed as a higher permission application, it may be set by the user to automatically interrupt or disable offending applications.

In one operational example of TM installed at high levels of permission, the TMA may be set to automatically put the device in “Airplane mode” when plugged into battery charger. The use of battery consumption as a proxy would be disabled while the device is charging, but by suspending all transmitters (as is the purpose of Airplane Mode), data cannot be transmitted. In this case, applications may still acquire data while the device is charging its battery(s), but can only store the data until the device is unplugged and normal operation restored. The collected data can then be transmitted, but since the battery consumption information is then available, the TMA will be able to discover and log such activity.

### E. Reporting Results

The Threat Monitor application can be configured to alert the user (or an administrator) in several ways. Pop-up, Audio, and Tactile are immediate while the others accumulate statistics for presentation. Multiple alerts can be set in combination.

### Pop-up Notification

The pop-up notification is used when the user desires both alerting and input into a decision criteria (e.g. allow/disallow). The pop-up notification works when the device is in use, that is the GUI is displayed. Pop up would be useful for notifying user that WiFi, Bluetooth, NFC, RFID network was trying to connect ideally by an identifiable notification (e.g. a Wi-Fi or Bluetooth beacon is offering to connect).

### Audio Notification

The Audio notification is primarily intended for when the device is on stand-by (i.e. the GUI is no displayed). The Threat Monitor plays a distinctive sound, connected to the operation or activation of a peripheral subsystem. In one exemplary system, activation of a communications subsystem would cause the sound of a dial-up modem bit rate setup, synchronization and rate negotiation tones while activation of a sensor subsystem would cause the threat monitor to play the recording of a rattlesnake, a snake hiss, a wolf howl or a cat's hiss depending on the sensor system activated.

### Tactile Notification

Using of the mobile device's silent, vibration alarm, the Tactile Notification is primarily intended for when the device is on stand-by (i.e. the GUI is not displayed) or when the GUI is occupied by a full-screen (maximized) application. The Threat Monitor plays a vibration or a sequence of vibrations depending on the sensor or communications subsystem activated.

### “While You Were Away” Notification

The “while you were away” notification starts when the device goes into sleep/stand-by mode and “pops up” this notification when device is awakened.

Following is an exemplary notification using a short form report that details the following:
i. Sensor Activation—which apps activated which sensors
ii. Data Transmission—which apps transmitted how much data and connected to which remote servers—summarized if space is a concern?
iii. Battery usage—which apps and radios used how much power while the phone was sleeping.

### Since Power-up Report

The Threat Monitor will supply the mobile device owner meaningful reports so they can see which apps are leaking what private data and which are the most power hungry since the phone was last powered-on or since the battery was last charged. Users will be able to choose to receive the reports on their device or via email.

### Periodic Reporting

The Threat Monitor will supply the mobile device owner meaningful reports so they can see which apps are leaking what private data and which are the most power hungry. Users will be able to choose to receive the reports on their device or via email.

Following is an exemplary report, the monthly report;
Monthly Notification Report—This report can be set by the user to be correlated with billing cycle.
   Show data usage by app.
   Show data transmission by each app (background) versus user initiated data transmission (foreground).
   Summarize which sensors and radios were activated by which apps. E.g. Google services transmitted your location 123 times during October or your camera was activated 23 times—5 times in the background.
   Show which apps, sensors, and radios are most power hungry.
   Generate a simple overall rating of the leakiness of user's phone and likelihood of being victimized.

### F. Community Awareness

Users may elect to have threat monitor statistics on activations, bandwidth use, and power consumption uploaded to an offline site in exchange for normalization data. Using multiple users' anonymous data, the threat monitor can then provide comparisons to industry-wide and other normalized profiles.

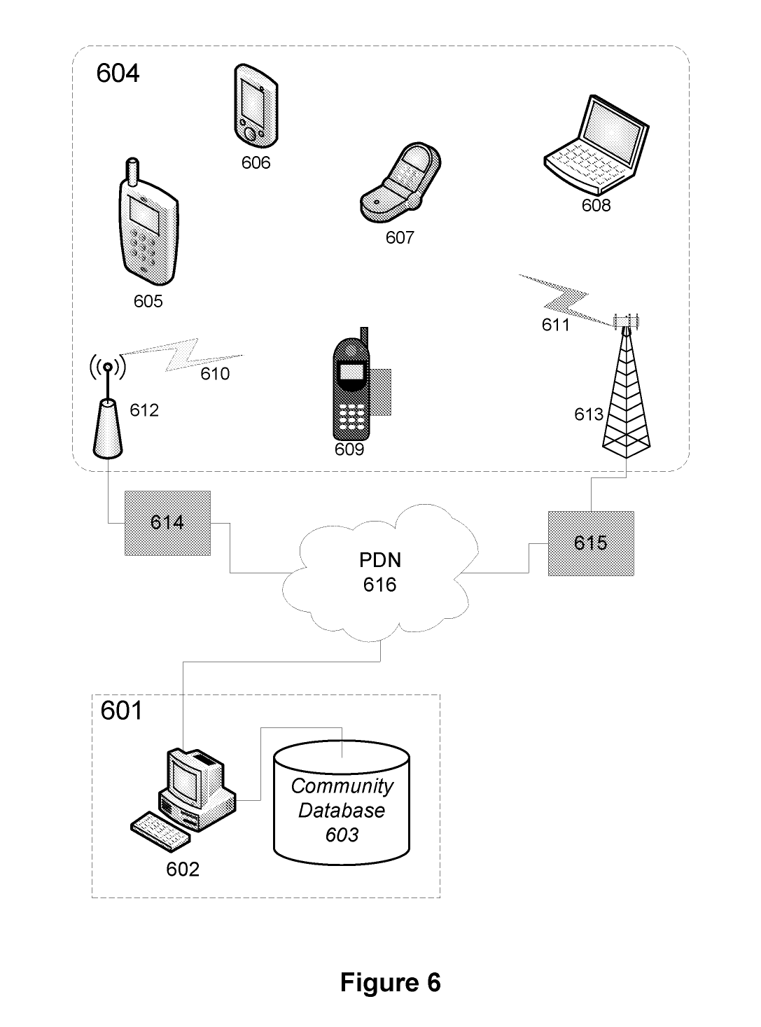

FIG. 6 shows an operational example of a use community. The back-office 601 contains processing servers 602 for data analysis and connected database 603 facilities for long term data storage. The back-office 601 may serve single or multiple service area(s) 604. The geographic coverage and number of users in a service area 604 may vary and multiple service areas may overlay the same geographic area. The service area may be defined for a temporary specific special purpose project or be a static for long term data collection. Single or multiple wireless carriers 612 613 may exist (or co-exist) in a service area 604.

In the service area 604, volunteer users with smartphones 605, wireless tablets 606, data capable feature phones 607 and wireless modem equipped personal computers (e.g. laptops) 608 may all contribute data. Using the radio signal 610 provided by local wireless local area network(s) 612 and/or the radio signal 611 provided by the local cellular wireless radio access network (RAN) 613 provider(s), the volunteers will upload data to the back-office 601. Uploaded data will traverse the WLAN packet infrastructure 614 or cellular network landside network 615 before being securely transmitted over the Public Data Network (e.g. the internet) 616 to the assigned back-office 601. Use of encryption at the volunteer device will guarantee data authenticity and data privacy.

In addition to the application data uploaded by the volunteers, some service areas 604 may be equipped with sentinel wireless devices 609. The sentinels 609 may be selected from a variety of manufacturers and be attached to specific wireless network(s) 612 613, but otherwise function in the same manner, and using the same data backhaul, as the volunteer devices. However, by supplanting the volunteers in a service area, the sentinel devices allow for broader manufacturer and model coverage but also allow for more data uploads and deeper analysis than is ethical with volunteers. For instance:
The back-office 601 can use deep packet inspection of data transmission(s) to reveal contents of unencrypted files compiled and sent by suspect device-based applications.
The back-office 601 can develop an off-device database of destination IP addresses for transmissions from suspect application. Once created, this IP database can be updated to provide file transmission info to users with the suspect application(s).
The back-office can use the sentinel 609 provided data samples to make inferences as to the behavior of a suspect application.

From the volunteer data, the sentinel data, and/or the combination of the volunteer and Sentinel data; information on suspect applications and rule sets based on positively identified offending applications can be provided to the volunteers and other users.

Additional services and information can be generated and supplied using the community of volunteers. Targeted campaigns based on selected applications or types of applications, or even target application users (e.g. corporate users, students, under-age children) can be performed to find violators of customer proprietary network information (CPNI), accumulators of Personally Identifiable Information (PII) or even violators of corporate espionage laws.

### G. Active Response

The threat monitor may be configured by the user to have an active response. Applications that allow the user to stop them may be automatically stopped or disabled when minimized or closed. The threat monitor may be set to automatically disable minimized or closed applications when the phone enters standby mode (e.g. the GUI is no longer being displayed). While the application is minimized or the phone is in standby mode, the threat monitor may be set to only act to disable an application if the application attempts activation of a (pre-set in threat monitor) protected subsystem, if the bandwidth used exceeds a pre-set threshold, and/or if power consumption exceeds a pre-set threshold. Such actions will be allowable if sufficiently high permissions/privileges can be obtained for the Threat Monitor Application.

### H. Alternative Embodiments

In an alternative embodiment, additional complementary or supplemental techniques (proxies) can be used with or in place of the power usage measurement technique as described to ascertain a location event in the mobile device has occurred and which applications on the mobile device initiated, received, and/or processed that location, communication or sensor event.

Types of inputs used as proxies for application (app) behavior (e.g. resource consumption) may include:
Observed power consumption
Observed CPU usage
GPS internal cache updated
WiFi turned on—cache detection
Linux route cache
IP address observed in route cache

The inference engine computes a confidence score that a particular app is behaving in a certain way (e.g. turning on GPS, camera, microphone or WiFi or sending data to a particular IP address) based on the number of observed behaviors, the historical pattern of observed behaviors, the number of competing apps that are active etc. Key to this confidence score is the determination of the state of the app—is it in use (foreground), background (active but hidden from user), or idle. This determination is done from the observed behaviors above using measurements from the proxy(s).

### Sensor Activation

Sensor activation and a certain app is fingered as culprit—largely done with inference engine described above. Take a number of inputs as proxies for behavior; gather observed behavior overtime in a database; continuously examine for patterns (known good behavior). For example: GPS is turned on, CPU is activated, Battery is drained; at Linux level track processes in memory by creating DB of memory usage; using machine learning techniques pattern match behaviors; compute confidence score; report results; repeat and repeat—increases confidence around observations and scoring.

In accordance with some aspects of the invention, this is done by taking a snapshot of the observed activities on the device every 8 seconds. In one working embodiment, the sentry programs observe over 48 different data elements and caches them in an encrypted on-device database. This same information is anonymously uploaded to the centralized database to compile information from many devices and create an industry-wide database of app behaviors.

Additionally, data that is exposed by or available from the operating system (OS) kernel can be used to ascertain the off-mobile destination address (nominally the destination Internet Protocol (IP) address).

As stated, the inference engine includes means of determining “bad” behavior (e.g. sending private data to malicious actors at random or non-random IP addresses). First, whitelist of known good addresses using public data (e.g. well-known addresses obtained from the public domain name system (DNS)). Second, compiling list of known bad actors IP addresses. Several organizations (e.g. scumware.org, SRI) maintain and publish blocklists (aka blacklists) of IP addresses and URLs of systems and networks suspected in malicious activities on-line which can be collected and downloaded to the served mobile devices. Third is taking sketchy observed app behavior (e.g. GPS or WiFi location data) and the fact that data is being sent to unknown IP address. This analysis would come with a confidence score as it is not deterministic. Fourth, observation of new sketchy behavior—packets being sent to new locations, large packets suddenly being sent, new behaviors observed e.g. camera or microphone being turned on etc. Reverse pattern matching or anomaly detection—good behavior has a known pattern of behavior when it is suddenly altered the assumption is that something malicious has occurred.

By observing the route cache in Linux, identifying the destination IP address, identifying the app sending the data packets to the IP address via the operation of the inference engine, the system uses DNS and WHOIS or Registration Data Access Protocol (RDAP) for lookup owner of IP address and where the IP address resides and determine whether packets have crossed borders based on the current location and/or network in use by the mobile device.

One such complementary or supplementary technique would be use of processor time as a proxy measurement in place or in addition to the power usage. Such information on applications running under control of the mobile device's OS is available at the system level and can at the user level. As an illustrative example, the UNIX “ps” or “top” commands which report processor usage of current and active processes respectively can be used at the normally unprivileged user shell level.

In modern mobile devices, applications are run sandboxed and identity and the processor usage for each application can be collected.

With this embodiment, the sentry application will itself register as a location listener. It may register for fine location and then in another instance register for coarse location. The sentry application also takes an inventory of applications loaded on the device and notes those that have location access permission. The identities of applications with location permission are stored for later use.

The application will poll the system for process runtime usage periodically. Several periods of the runtime usage for each process will be stored. Optionally, the idle level for each process can be timestamped and stored for later averaging as part of a calibration process.

Network usage may also be collected on a periodic basis and several periods of network usage data stored. All stored network data will be time-stamped with the time of acquisition.

At some point in time, the sentry application is informed that a location event has occurred and that new location data is available. The sentry application then begins analysis using the stored process runtime data, the stored location capability data and the time of the current location event. By correlating the time with the runtime levels of the location capable processes, the sentry application can determine which applications received the current location event. The correlation result would then be stored.

Using the stored time-stamped network usage data and the time-stamp for the currently location event, the network activity for each location capable application can be determined allowing determination of which application is transmitting the location information off the mobile device. The correlation results from the processor usage technique and optionally the associated network activity are then stored.

Other location-related information, such as from an application's power use as described, can also be used in the correlation equation. Use of a weighted sum of sources allows for multiple correlations to be performed separately, this allows the location listener detection technique to cope with differing capabilities afforded to different makes, models, and versions of the mobile device and operating system where power usage or access to run-time processor use by non-privileged applications may be restricted.

Dependent on user elections, the correlation results from the location event and optionally the associated network activity can be delivered to the user in near real-time, or as part of an event or periodic generated report.

The type of app (normal foreground app launched by user, background service, or system service) is also taken into consideration.

In another alternative embodiment, the location listener determination technique can be trained over time to improve individual correlations and the weighted summation of correlation results.

Simple averaging over longer time spans is the first method of training the technique. The technique can also retrospectively increase or increase likelihood of detection for a particular app if at some point later it becomes known that for certain the app does or does not follow some observed usage pattern. Initially several applications may all score the same correlation value, over time and location determinations, applications that are not receiving, processing or transmitting the mobile device location may be filtered out by declining correlation summation.

User feedback can also be used local to the mobile device or as shared among the community of users. The described training technique can incorporate user feedback (e.g. the mobile device user can whitelist an app) from the user interface (UI), and/or from aggregate (crowdsourced) feedback obtained from subscribed users or via the internet-based service portal.

The true scope the present invention is not limited to the presently preferred embodiments disclosed herein and indeed could be applied to any reprogrammable remote sensing or other computing device that creates, saves and transmits information that a user or owner could consider sensitive. For example, the foregoing disclosure of a presently preferred embodiment of the Threat Monitor Application uses explanatory terms, such as mobile device, API, Foreground, background, user interface and the Airplane Mode and the like, which should not be construed so as to limit the scope of protection of the following claims, or to otherwise imply that the inventive aspects of the Threat Monitor Application are limited to the particular methods and apparatus disclosed.

Moreover, as will be understood by those skilled in the art, many of the inventive aspects disclosed herein are based on software applications and operating systems running on generic hardware processing platforms. These functional entities are, in essence, programmable data collection, analysis, and storage devices that could take a variety of forms without departing from the inventive concepts disclosed herein. In many cases, the place of implementation (i.e., the functional element) described herein is merely a designer's preference and not a hard requirement. Accordingly, except as they may be expressly so limited, the scope of protection of the following claims is not intended to be limited to the specific embodiments described above.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Accordingly, elements or features of the invention described herein as coupled have an effectual relationship realizable by a direct connection or indirectly with one or more other intervening elements. Representative illustrative methods and materials are also described, but are not intended to limit the scope of the invention, which is defined by the claims that follow.

All statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. It is noted that, as used herein, the singular forms “a,” “an” and “the” include plural referents unless the context clearly dictates otherwise. Reference throughout this specification to “one aspect,” “another aspect,” “one embodiment,” “an embodiment,” “certain embodiment,” or similar language means that a particular aspect, feature, structure, or characteristic described in connection with the embodiment is included in at least one embodiment of the invention. Thus, appearances of the phrases “in one embodiment,” “in at least one embodiment,” “in an embodiment,” “in certain embodiments,” and similar language throughout this specification may, but do not necessarily, all refer to the same embodiment or similar embodiments.

Elements described herein as coupled have an effectual relationship realizable by a direct connection or indirectly with one or more other intervening elements.

The scope of the present invention, therefore, is not intended to be limited to the exemplary embodiments shown and described herein. Rather, the scope and spirit of present invention is embodied by the appended claims.

1. A mobile device operable to communicate with at least one of a wired network and wireless network, the mobile device comprising:
a processor;
at least one transceiver coupled to the processor;
at least one sensor coupled to the processor; and
memory coupled to the processor, the memory including instructions that upon execution cause the processor to:
execute an operational procedure analysis of resource consumption of at least one application on the mobile device that accesses peripheral subsystems of the mobile device; and
log the resource consumption.

2. The device as in claim 1, wherein the peripheral subsystem includes the at least one sensor.

3. The device as in claim 1, wherein the peripheral subsystem includes a transceiver.

4. The device as in claim 1, wherein the resource consumption is power consumption.

5. The device as in claim 1, wherein the resource consumption is CPU usage.

6. The device as in claim 1, wherein the resource consumption is internal cache use and updating.

7. A method comprising:
monitoring resource consumption of an application running on a plurality of devices connected to a central database;
collecting information about the resource consumption of the application running on each of the plurality of devices over a period of time to build a historic behavior profile for the application;
comparing, for any one device of the plurality of devices, the application's resource consumption to the historical behavior profile; and
determining if the application, running on the one device of the plurality of devices, is behaving consistently with the application's historic profile.

8. The method of claim 7 further comprising deactivating the application if the application's behavior is not consistent.

9. The method of claim 7, wherein the resource consumption is power consumption.

10. The method of claim 7, wherein the resource consumption is CPU usage.

11. The method of claim 7, wherein the resource consumption is internal cache use and updating.
